(19) United States
(12) Patent Application Publication
(10) Pub. No.: US 2010/0231511 A1
(43) Pub. Date: Sep. 16, 2010

(54) INTERACTIVE MEDIA SYSTEM WITH MULTI-DIRECTIONAL REMOTE CONTROL AND DUAL MODE CAMERA

(75) Inventors: David L. Henty, Newport Beach, CA (US); Christopher Cooper, North Vancouver (CA)

Correspondence Address: David L. Henty, Suite 1150, 19900 MacArthur Blvd., Irvine, CA, 92612, US

(73) Assignee: David L. Henty

(21) Appl. No.: 12/721,225

(22) Filed: Mar. 10, 2010

Related U.S. Application Data
(60) Provisional application No. 61/159,071, filed on Mar. 10, 2009.

(51) Int. Cl. G06F 3/033; H04N 5/44

(52) U.S. Cl. 345/157; 348/734; 348/E05.096

(57) ABSTRACT

A multi-directional remote control system and method is adapted for use with an interactive media system of a type including a display such as a monitor or TV with a camera. The remote control system and method images the controller to detect relative motion between the controller and screen with the camera. This position information is used for control of a cursor or other GUI interface. A movable IR filter improves detection of the IR during tracking and allows the camera to have a second function, such as a web cam or other function, with the filter not in place.

### RELATED APPLICATION INFORMATION

The present application claims priority under 35 USC 119 (e) to U.S. provisional application Ser. No. 61/159,071 filed Mar. 10, 2009, the disclosure of which is incorporated herein by reference in its entirety.

### BACKGROUND OF THE INVENTION

1. Field of the Invention

The present invention relates to interactive media systems and remote control systems for controlling such systems, such as televisions, multimedia systems, Internet access systems and browsers, and related methods.

2. Description of the Prior Art and Related Information

A need has arisen for providing multi-directional mouse type control capabilities in the living room along with the ability to control the conventional entertainment devices typically present in the living room. For example, combined PC and TV systems have been introduced which integrate the capabilities of the personal computer with the television. One such system is described in U.S. Pat. No. 5,675,390. Also, set top Internet access devices have been introduced which integrate Internet access capabilities with conventional televisions. The ability to provide full control of a PC or an Internet browser typically requires the use of a keyboard and a multi-directional controller such as a mouse. A conventional remote control is therefore inadequate for control of such combined entertainment systems. Also, the advent of digital video recorders (DVRs), wireless networking systems for video, audio and picture transfer to TVs, and other digital devices linked to the TV has introduced many more functions to TV control, including complex display menus, introducing a need for a better remote control interface.

Wireless keyboards are one addition to the conventional remote control in the living room that have been introduced to allow the user of a combined PC and TV system or the user of a TV Internet access device to provide convenient text input, for example for creating emails or searching. However, convenient control of PC type functions also requires an ability to interface with a Graphical User Interface (GUI). To address this need wireless keyboards may include an up-down-left-right control to move around in a limited GUI interface. This type of up-down-left-right control is also typically added to conventional remotes and used to navigate a cable TV menu or digital TV peripheral device menu, such as a DVR. This type of up-down-left-right control is more restricted and clumsy to use than a mouse type controller and limits the flexibility of a GUI interface and the menu layout. Alternatively, wireless keyboards may include an integrated trackball or other pointing device to provide mouse type control of the PC or Internet functions. These types of multi-directional controls are less natural and convenient to use than a separate mouse controller. Also, such systems require both hands to use making simple one handed navigation of a GUI TV interface impossible. A wireless mouse controller is an option, however, a mouse requires a clean flat surface within easy reach and is not convenient for a living room setting. Some attempts have been made to provide a mouse type controller suitable for living room use, for example, using gyroscopic motion detection, however such controllers suffer from various problems such as cost, complexity and lack of naturalness of use. Furthermore, to provide all the desired types of controls of a PC/TV entertainment system three separate wireless remote controls would be needed, a hand-held remote control, a wireless keyboard and a freely movable mouse type control. This of course introduces undesirable cost, a confusing number of control functions, and clutter in the living room.

Accordingly, the addition of complex digital devices as well as PC and/or Internet access capabilities to the conventional TV based entertainment system has introduced the problem of controlling such systems with a convenient yet full function remote control system.

### SUMMARY OF THE INVENTION

In a first aspect the present invention provides an interactive media system with dual mode camera operation, comprising a display, a camera assembly integrated with or adjacent to the display and including a camera having a lens oriented toward an area in front of the display, the assembly further including a movable filter holder and a filter configured in the holder, wherein the filter holder is movable from a first position where the filter covers the camera lens to a second position where the filter is not covering the lens, a remote control including an LED, and a processor implementing a tracking algorithm based on images of the LED from the camera with the filter in the first position and controlling a cursor or other object on the display using the detected LED position.

In a preferred embodiment of the interactive media system the. LED is an IR LED and the filter is an IR pass and visible light blocking filter. The camera assembly preferably further comprises an actuator for moving the filter from the first position to the second position. The actuator may be activated by a control signal in response to initiation of tracking operation by a user. The movable filter holder may comprise a slidable holder or, alternatively, a rotatable holder. A second filter may be configured in the movable filter holder wherein the second filter is an IR blocking filter and wherein the second filter covers the camera lens when the filter holder moves to the second position.

In another aspect the present invention provides a method of dual mode operation of an interactive media system including a display, a camera and a remote control having an LED. The method comprises operating the interactive media system in a first mode where a cursor or other object displayed on the display is controlled by tracking movement of the remote control by tracking the LED using the camera with a filter in a first position in place over the camera lens to enhance the LED tracking operation, moving the filter to a second position not covering the camera lens, and operating the interactive media system in a second mode with the camera employed for a web video application with the filter in the second position.

In a preferred embodiment of the method of dual mode operation of an interactive media system the LED is an IR LED and the filter is an IR pass and visible light blocking filter. The method may further include moving a second IR blocking filter to cover the camera lens when the interactive media system operates in the second mode.

Further features and advantages will be appreciated from the following detailed description.

### BRIEF DESCRIPTION OF THE DRAWINGS

FIG. 1 is a perspective view of an improved entertainment system in accordance with the present invention in a presently preferred embodiment.

FIG. 2 is a top view of the remote controller of the present invention in a presently preferred embodiment.

FIG. 3 is a block schematic diagram illustrating control circuitry of the remote controller of the present invention.

FIG. 4 is a schematic diagram illustrating the image data captured by the imager of FIG. 1.

FIG. 5 is a schematic diagram illustrating the image data after background processing, which image data corresponds to the desired image data, and derived relative position information.

FIG. 6 is a flow diagram illustrating the processing of image data by the system of the present invention.

FIG. 7 is a simplified schematic of the display control/input device of the system of FIG. 1.

FIG. 8 is a flow diagram illustrating the process flow of the display control/input device for converting detected position data to a cursor or other GUI multi-directional control function.

FIGS. 9-18 illustrate several embodiments of a camera assembly with movable filter allowing the media system camera to have dual functions including tracking for cursor control and use as an interactive web cam or other function.

### DETAILED DESCRIPTION OF THE INVENTION

The disclosures of US utility patent application Ser. No. 11/255,647 filed Oct. 21, 2005, PCT application PCT/US2006/041306, filed Oct. 23, 2006, now assigned utility patent application Ser. No. 12/083,811, and provisional application Ser. No. 61/159,001 filed Mar. 10, 2009, are incorporated herein by reference in their entirety.

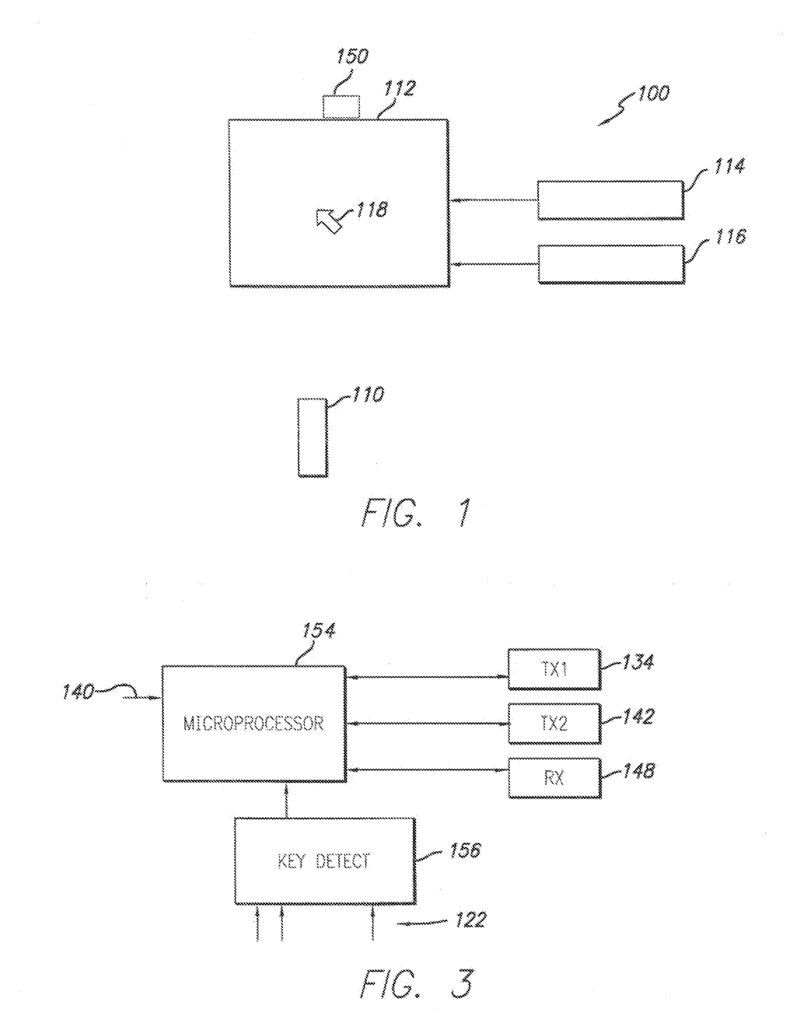

The present invention provides an interactive media system, and a camera based multi-directional remote control system and method adapted for use with such a system, employing a multi-directional control function such as a GUI control interface. Any such multi-directional control capability is referred to herein, for shorthand purposes only, as a GUI interface. In FIG. 1 an improved interactive media or entertainment system in accordance with the present invention is illustrated in a perspective view in a presently preferred embodiment. Details of such systems beyond the novel control features described herein are known and will not be described in detail herein. For example, a PC/TV system with internet access is one example of such an entertainment system and is disclosed in the above noted '390 patent, the disclosure of which is incorporated by reference in its entirety.

In one embodiment this invention is directed to an interactive media system employing a remote control method for moving a cursor on a screen of a display by analyzing images of one or more LEDs contained in a handheld remote control captured by a stationary camera in proximity to the screen. The user presses and holds a predefined button on the remote control to move the cursor. The signal from the remote control activates a tracking algorithm on a microprocessor, which analyzes captured images of the LEDs to calculate a displacement for the cursor and move the cursor. When the user releases the predefined button, the tracking algorithm stops. Performance of the system is enhanced by placing a filter over the camera lens which allows only wavelengths similar to those emitted by the IR LED(s) in the remote control to pass through the filter. This application describes a variety of embodiments for movably positioning a filter in front of a camera lens to create a dual mode camera, in which one mode is for cursor control, and the other mode is for other interactive applications such as web conferencing.

Referring to FIG. 1, the entertainment system 100 includes a multi-directional remote controller 110, a display 112, which for example may be a TV or monitor, a primary display control/input device 114 and a secondary display control/input device 116. Primary display control/input device 114 and secondary display control/input device 116 may comprise any of a variety of devices using a TV or display for output. Primary control/input device 114 is adapted for a GUI interface control displayed on the display 112. For example, the primary input device 114 may comprise a multi-media PC such as in the above noted '390 patent or other device adapted for utilizing a multi-directional control, such as a GUI interface. Other examples of primary input device 114 include digital cable or satellite TV boxes, DVR systems, networked digital media systems adapted for media transfer from a networked PC, Internet steaming media devices, digital video game players, etc. A variety of possible devices may therefore comprise primary input device 114. Furthermore the functionality of input device 114 may be incorporated in the display system 112 and is simply illustrated as a separate device for illustration of one possible configuration. Secondary input device 116 may also comprise any of a variety of known devices employed in entertainment systems and may include a DVR, cable TV box, or other digital or combined analog and digital interface device. Device 116 may incorporate a GUI type interface or a more conventional interface for TV systems adapted for, e.g. a push button LED remote control. Also, the functionality of device 116 may be incorporated along with device 114 or display 112 and again the illustration of a separate input device is purely for illustration of a possible configuration and without limitation. Plural devices 114, 116 are shown to clarify that the control system of the present invention may control a conventional device as well as a GUI device, with an (optional) combined universal remote/multi-directional control capability in one embodiment of a controller 110 as described below.

System 100 includes an imager or camera assembly 150 which receives light in its field of view including IR light from conventional IR LED(s) in controller 110. Imager 150 may comprise a suitable commercially available digital imager, for example commercially available imagers providing relatively high-quality digital images and which are sensitive to IR light are available at relatively low cost and may be advantageously employed for imager 150. The output of imager 150 will be image data corresponding to the pixels in the field of view of the imager 150, which field of view is suitably chosen to encompass the area in front of the controller including the controller 110 shown in FIG. 1. An IR filter may advantageously be provided in front of the imager or incorporated in the camera lens assembly to reduce background image while passing the IR light from controller 110. Embodiments of such a filter and movable positioning in the camera assembly 150 are described below. The pixel data output from imager 150 is provided to a processor in device 114 which may be a suitably programmed general purpose processor, forming part of a PC for example, programmed in a manner to provide the image processing and cursor control functions described in more detail below.

Remote controller 110 in combination with the imager and image data processing provides a multi-directional control capability which is schematically illustrated by control of cursor 118 displayed in the monitor 112. The image data may be processed to provide absolute pointing position control over cursor 118 or the data may provide movement control over the cursor corresponding to changes in image position between frames. It should be appreciated however that a variety of different multi-directional control interfaces may be employed other than a cursor such as in a typical mouse control of a PC. For example the multi-directional controller 110 may control highlighting and selection of different icons or other GUI interface layouts displayed on the screen of display 112 by device 114 and/or device 116. Also, the multi-directional controller could simply enable rapid scrolling through large channel lists such as in digital cable menus without the tedious up-down-left-right scrolling typically employed. As will be described in more detail below, remote controller 110 thus provides a freely movable multi-directional motion based control similar to a mouse control of a PC but without being limited to use on a flat surface.

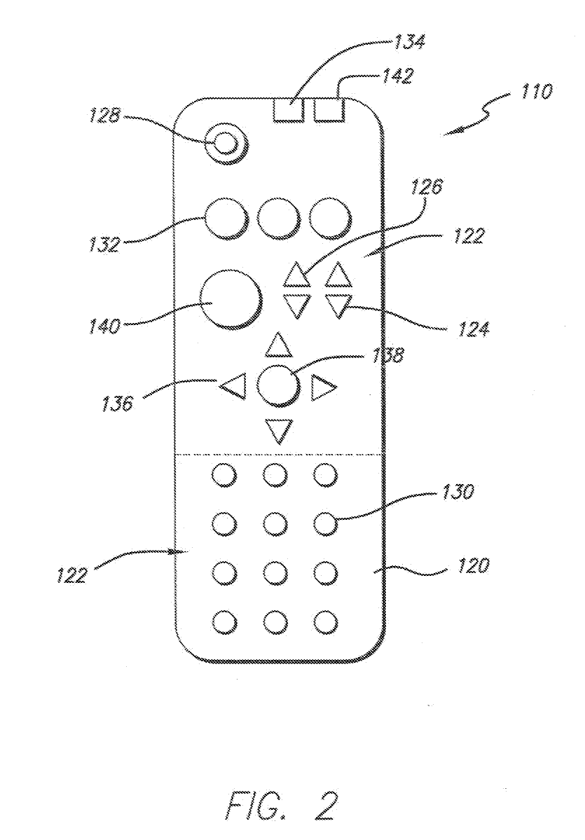

Referring to FIG. 2, the remote controller 110 is illustrated in more detail in a top view. As shown, the remote controller may have a configuration similar to a typical remote control employed in an entertainment system. Alternatively, the controller 110 may have a shape more similar to a mouse type controller or other desirable ergonomic configuration adapted for use in one hand in a living room setting. The top surface of the controller housing 120 may include a number of first remote control inputs indicated generally at 122. This first set of control inputs 122 may include conventional remote control functions typically found in hand-held TV remote controls or universal remote controls adapted to control multiple entertainment devices such as TVs, DVRs, CD players, DVD players, etc. Therefore the first set of remote control inputs 122 may include the volume up and down set of controls 124, a channel up and down set of controls 126, a power button 128 and a set of numeric inputs 130. Also, a number of programmable or special purpose control buttons may be provided that are indicated generally as buttons 132. As further illustrated in FIG. 2, the first set of controls 122 preferably include conventional up, down, left, right (UDLR) navigation buttons 136 and an OK or Select button 138 which together provide conventional navigation of a menu. The first set of controls 122 activate a conventional IR LED wireless transmitter 134 configured at one end of the housing 120. A button 140 is preferably provided to activate the multi-directional control capability of the controller 110 by transmitting a control signal to device 114 via IR transmitter 134. This may at the same time cause the control input device 114 to display cursor 118 and/or a suitable menu adapted for multi-directional control on the display screen 112. The imager 150 detects the IR signal from the controller and moves the cursor. With the multi-directional control by image data processing the remote 110 thus provides dual mode navigation in a simple conventional remote configuration.

Although one button 140 is shown several menu buttons may be provided which enable display of the appropriate menu and at the same time enable the multi-directional control capability. Also some or all of the functions of inputs 122 may be allocated to GUI control on the screen. The controller 110 may also provide various degrees of enhanced “universal control” GUI capability over various devices, such as device 116 or TV 112 as described in more detail in the above noted '647 and '811 applications.

Referring to FIG. 3, a block schematic diagram is illustrated showing the circuitry of the remote controller. As shown in FIG. 3, the controller circuitry includes microprocessor (or microcontroller) 154 which controls IR transmitter 134 to transmit signals to the output control device 114 (or 116) shown in FIG. 1 in response to activation of keys 122 (shown in FIG. 2) provided from key detect circuit 156. Microprocessor 154 may also store codes for universal control operation. An (optional) receiver 148 may also be provided, e.g. to receive a signal from device 114 with information from device 114, e.g. to customize the control functions for different GUI interfaces. If device 114 has a networked wireless interface, such as a WiFi interface, controller 110 may also employ this protocol and be networked with device 114. Microprocessor 154 also receives as an input the control signal from switch 140 which, as described in detail in FIG. 5, may transmit a control signal from transmitter 134 to activate a menu or other interface signaling activation of the multi-direction controller function and a GUI interface. A single IR transmitter may be employed for transmitting both modulated control signals and a IR signal for tracking under the control of microprocessor 154. Two transmitters 134 and 142 may be advantageously employed however were the control signals from switches 122 provide a conventional LED type control signal which may be used for standard remote protocols and IR transmitter 142 provides a signal better adapted for tracking, for example, having a different transmission scheme with less or no off modulation for easier tracking or a wider beam pattern or higher power. Also, both IRs 134, 142 may be activated simultaneously during tracking operation for added brightness and to provide a two LED image as an aid in detection and tracking.

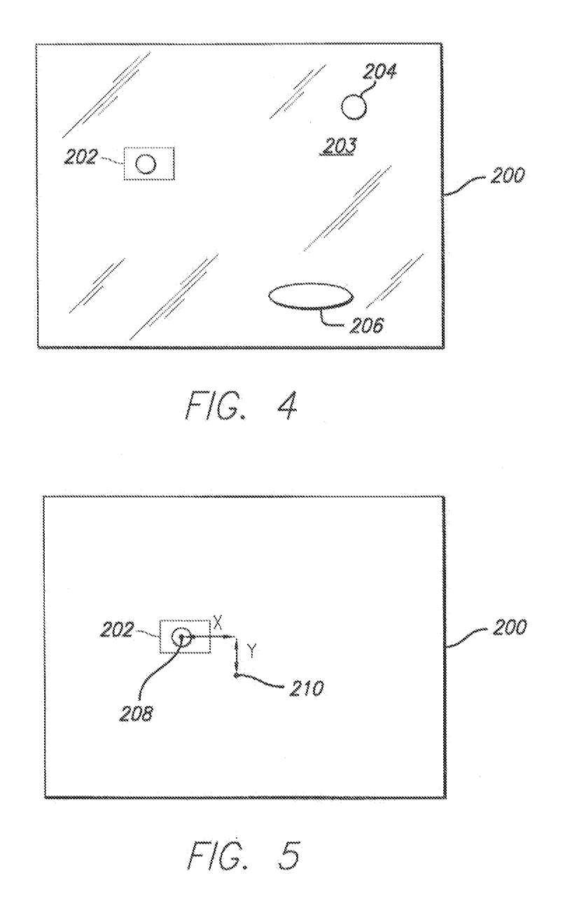

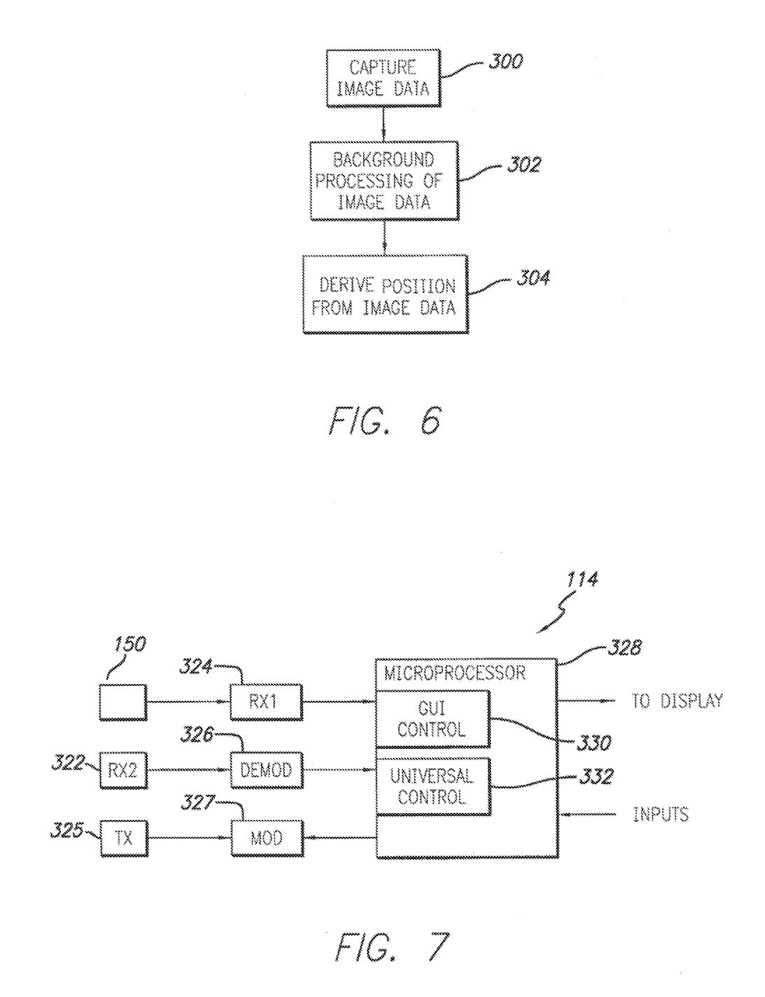

Next, referring to FIGS. 4-6 the image processing implemented by processor 328 in FIG. 7 will be described in more detail. First of all, referring to FIG. 6 the first stage in the image processing is to capture a frame of image data as illustrated at 300. In FIG. 4 the image data captured by imager 150 is illustrated. As shown, the field of view 200 includes image data (pixels) 202 corresponding to the desired object (remote control 110 shown in FIG. 1) as well as background image data 203. The image data 202 has several characteristics which distinguish it from the background and which allow it to be reliably detected by the image processing software. These characteristics include the following: the image data 202 will be brighter than the background (after IR filtering); the image data 202 will not be static (the remote will be in motion); and the IR within image region of interest 202 will have a round shape. These characteristics may be employed to eliminate the irrelevant background images and clearly discern the image 202. Next, referring to FIG. 6, at 302, the image processing flow proceeds to eliminate background image data and isolate the image data 202. This processing employs some or all of the above noted unique characteristics of the image 202 to eliminate the background image data. In particular, as shown in FIG. 4 by the shaded area, a majority of the background image data 203 will have a brightness substantially less than image data 202 and this portion of the background can be rejected by rejecting the pixel data below a reference brightness threshold. The remaining groups of image data will correspond to relatively bright objects which may occur in the field of view, illustrated for exemplary purposes in FIG. 4 by image data 204, 206. For example, such image data may correspond to a bright object such as a lamp's image data 204. Also, reflected image data 206, for example corresponding to a reflection off of a coffee table or other reflective surface in the field of view may be present. Image data 204 and 206 may be readily eliminated by using shape and movement selective processing described in more detail in application Ser. No. 61/159,001 incorporated by reference in its entirety. Additional characteristics of the desired data 202 may be used if necessary. Also, reflections of the remote LED itself may be eliminated by doing a comparison of the brightness of the two images and selecting the brighter of the two objects. Furthermore, the reflections may be substantially eliminated from the image data by employing a polarized filter in the lens assembly 144.

In the unlikely event that the image processing locks onto an incorrect object a simple reset may be provided, e.g. simply releasing button 140 or some other manually activated input. This allows the user to reset the image tracking system, for example if it inadvertently locks onto a window in a room, after pointing the controller at the display screen and hitting a reset button.

After the above noted processing the remaining image data corresponds to the desired image data 202, namely an area of interest surrounding the remote LED, as generally illustrated in FIG. 5. The processing flow then proceeds to derive the center of the image from this remaining image data at processing step 304, illustrated in FIG. 6. The process flow next proceeds to derive the relative position of the center of the detected image 208 to the center 210 of the field of view 200 (and the center of the optical axis of the imager lens assembly). As shown in FIG. 5, this offset information may be readily calculated from the image center pixel information derived previously and offset values X,Y may be derived as shown. Alternatively, purely image feature motion detection may be used for the multi-directional control, without employing the relative position offset of the imager axis to the detected image feature. Instead changes in the position of the detected image feature between frames may be used to provide motion control. The position information determined at 304 may then be just the change in image position from a prior frame. However, while the approach using imager axis offset information allows either pointing position based or motion based control, this approach only allows the latter.

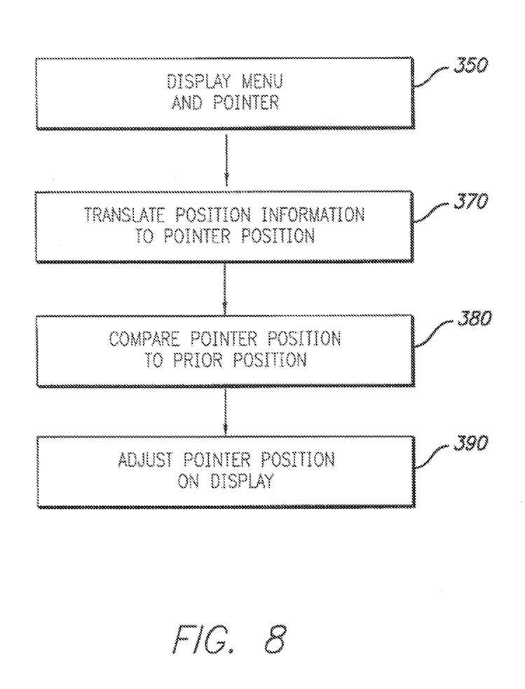

Next, referring to FIGS. 7 and 8 the control processing using the position data, is shown.

As shown in FIG. 7 the input device 114 will include a receiver 324 for receiving the image data from camera 150, which may be a standard port if a wired connection to the camera is provided. An IR receiver 322 is provided for receiving the remote control input signals from the control inputs 122 on the remote control and also from the multi-directional control button 140. The receiver 322 is coupled to suitable demodulation and amplification circuits 326, which in turn provide the received demodulated IR transmitted data to a microprocessor 328. A transmitter 325 and modulator 327 may also be provided to communicate with the controller 110 or a networked wireless device. Microprocessor 328 will perform a number of functions which will depend on the particular device and will include functional block 330 for providing image processing and control of a GUI interface based on received image data from the camera and functional block 332 for providing remote-control functions from the other inputs 122 in controller 110. Although these functional blocks are illustrated as part of the system microprocessor 328 and may be programs implemented on a general purpose processor, it will be appreciated they may be also provided as separate circuits or separately programmed microprocessors dedicated to the noted functions.

Referring to FIG. 8, a simplified process flow for converting the position data to a multi-directional control function is illustrated. As shown at 350, the process flow begins when a GUI or other multi-directional control mode is entered and the appropriate display will be provided on the display screen 112. Next the process flow activated by entry into the multi-directional control mode operates to determine the position of the controller 110 as described above. At 370 the position information is then processed and translated to cursor position information. Converting the position information to cursor position control information at 370 may employ a variety of different functions depending on the particular application and entertainment system configuration and intended use. In general, this translation operation will provide a mapping between the received position information and cursor position based on a sensitivity which may be user adjustable. In particular, the user may choose to adjust the sensitivity based on how close the screen is to the user which will affect the amount of angular motion of the controller 110 required to move the cursor a particular amount in the display screen. An automatic cursor speed sensitivity control may also be provided. Additional details on cursor movement control are described in the '001 application, '811 application and '647 application.

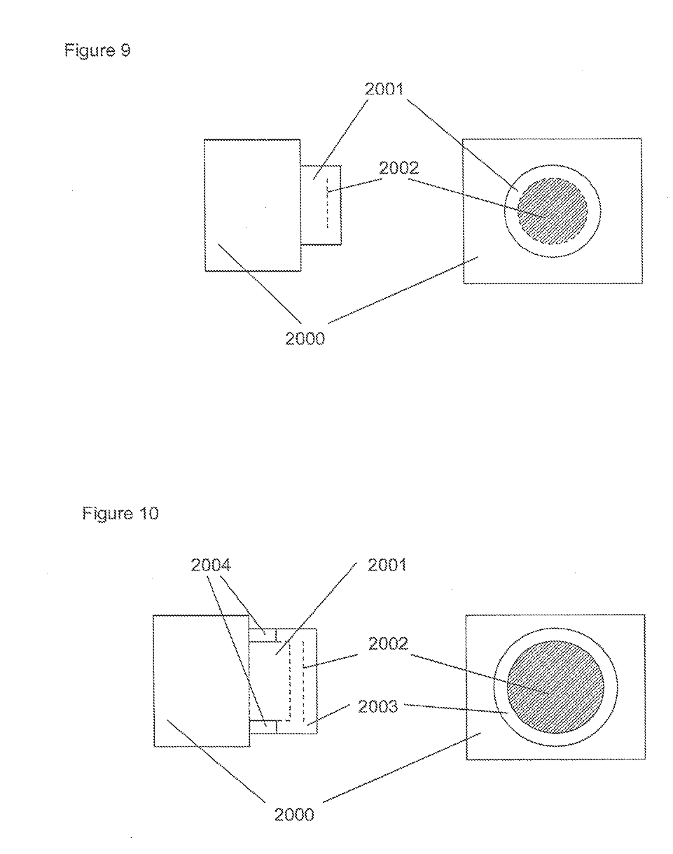

Referring to FIGS. 9-17 several embodiments for positioning a filter in front of the camera lens of camera 150 to create a dual mode camera, in which one mode is for cursor control, and the other mode is for other applications such as web conferencing are described. When the filter is in position, only wavelengths of light similar to the LED(s) in the remote control are allowed to reach the camera, enhancing performance of the described cursor control system. For an IR LED this filter is preferably an IR pass but visible light blocking filter making applications like web video/video phone impossible. Moving the filter away from the lens makes such dual mode use of the camera possible.

First camera assembly 150 is shown in more detail in FIG. 9 showing a camera 2000 in side view (left) and front views (right), with lens 2001 and filter 2002.

A first embodiment of a movable filter and dual mode camera employs a filter holder with an embedded filter, and magnets for easy attachment and removal of the filter holder to a non-dedicated camera which is used for multiple purposes. FIG. 10 shows an example of this embodiment, showing a camera 2000 (side view (left) and front view (right)) with lens 2001, filter holder 2003, integrated magnets 2004 and integrated filter 2002.

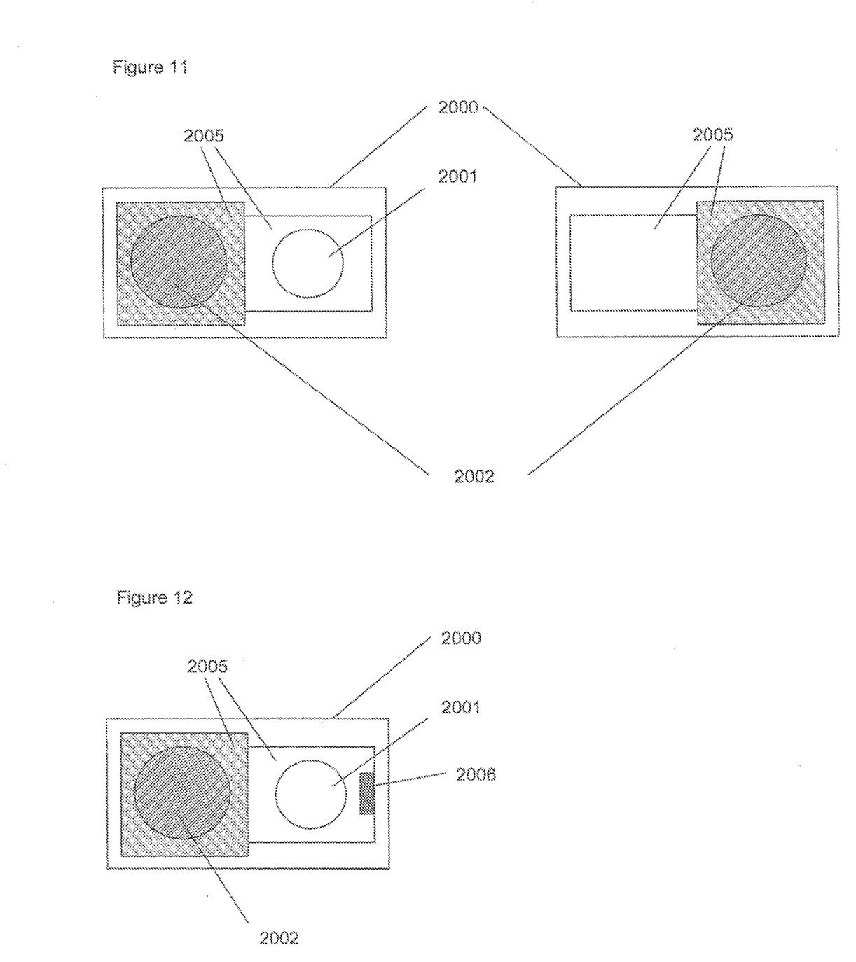

Another embodiment of a movable filter and dual mode camera employs a filter holder with a sliding mechanism allowing the filter to be deployed in front of the lens as required. The filter holder can be affixed permanently to the camera in this case. FIG. 11 shows an example of this method, showing a camera 2000, lens 2001, sliding filter holder 2005 with integrated filter 2002, in the non-deployed (left) and deployed (right) positions.

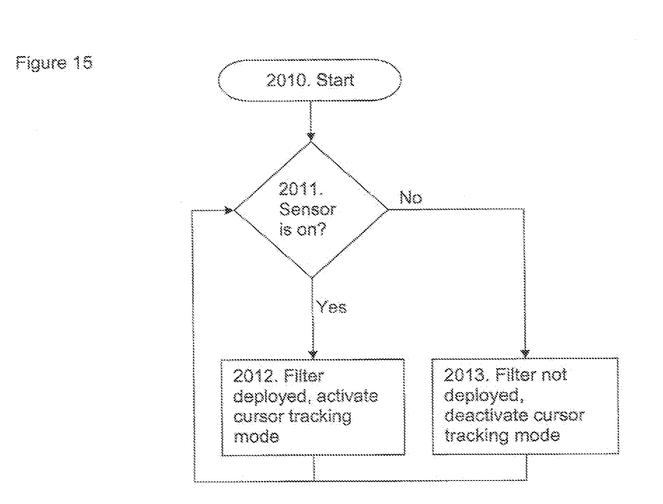

FIG. 12 shows an alternative mechanism which includes a sensor 2006 which signals the microprocessor that the filter has been deployed, causing the microprocessor to engage the camera and initiate the algorithm for tracking the remote control IR LED and controlling the cursor (as described above and in the above noted applications incorporated herein). FIG. 15 illustrates the process flow. In step 2011 the sensor is examined. If the sensor is on cursor control and IR LED tracking by the camera is activated 2012, otherwise cursor control and tracking is deactivated 2013.

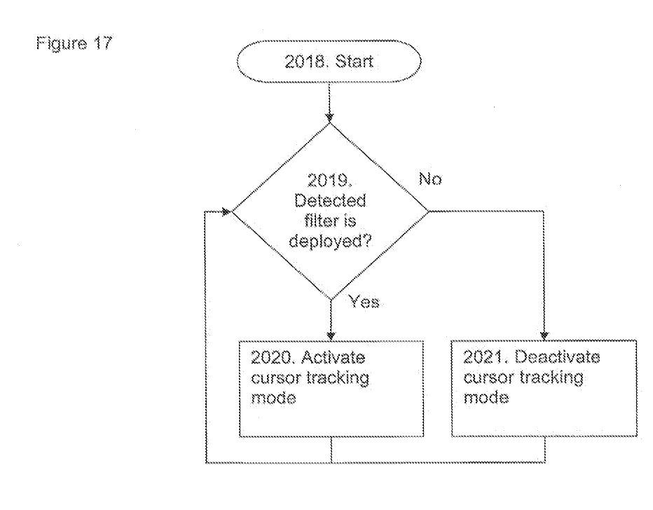

FIG. 17 illustrates an alternative method for automatically activating or deactivating cursor tracking without use of a sensor. In this method image analysis on the camera image is employed at step 2019 to detect whether the filter has been deployed by the user. If the image analysis determines that the filter is deployed, cursor control and IR LED tracking by the camera is activated 2020; otherwise cursor control and tracking is deactivated 2021.

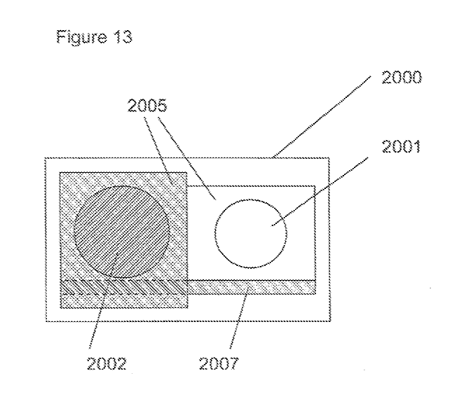

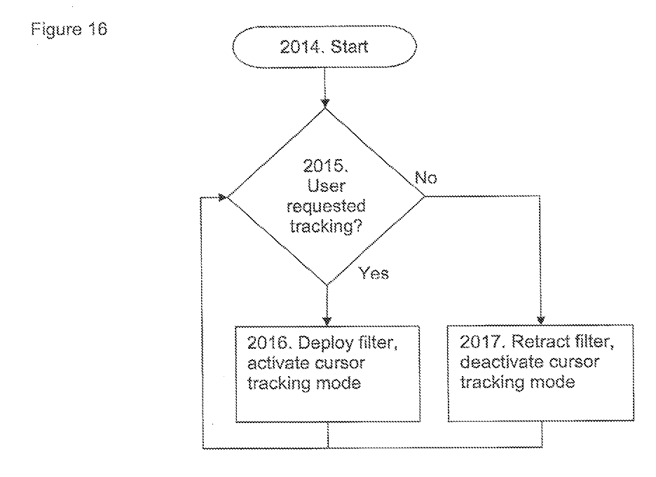

FIG. 13 shows an alternative embodiment which includes an electromechanical mechanism 2007 which allows the microprocessor to automatically deploy the filter in response to commands issued by the user to the microcontroller, for example by selecting a menu item or by pressing a button on the remote control. FIG. 16 illustrates the process. In step 2015 a check is made to determine if the user has requested cursor tracking. If tracking is requested, the filter is deployed 2016 by the electromechanical mechanism, otherwise the filter is retracted 2017 by the electromechanical mechanism. A variety of known electromechanical mechanisms may be employed; for example small inexpensive actuators employed in camera shutters and auto focus systems are known and can be quickly actuated under microprocessor control.

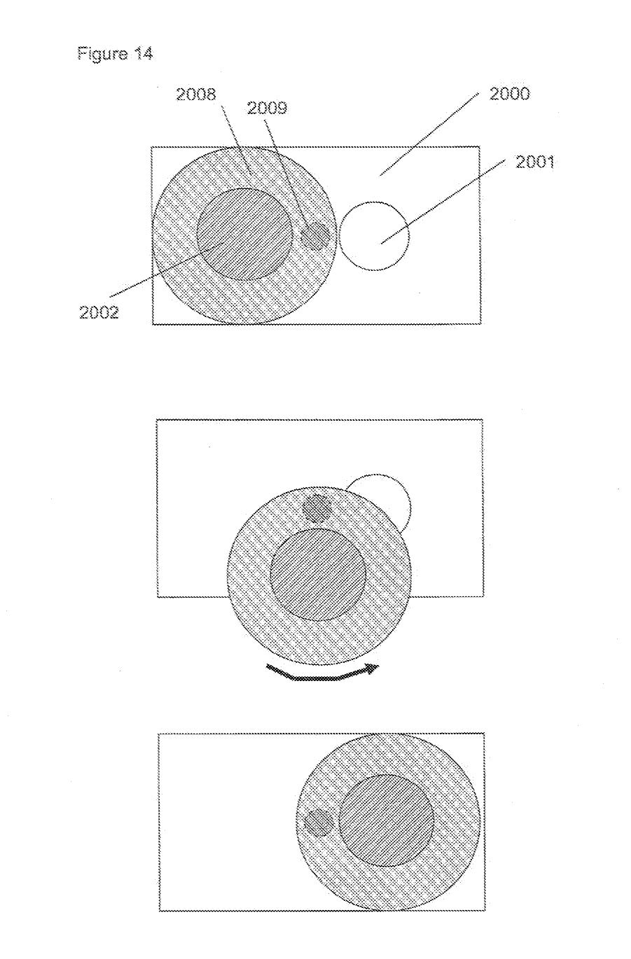

FIG. 14 shows an alternative embodiment which employs a rotating filter holder mechanism (2008, 2009). This mechanism may also include a sensor similar to that described for the sliding mechanism to signal the microprocessor that the filter has been deployed. This mechanism may also include an electromechanical mechanism similar to that described for the sliding mechanism to automatically deploy the filter.

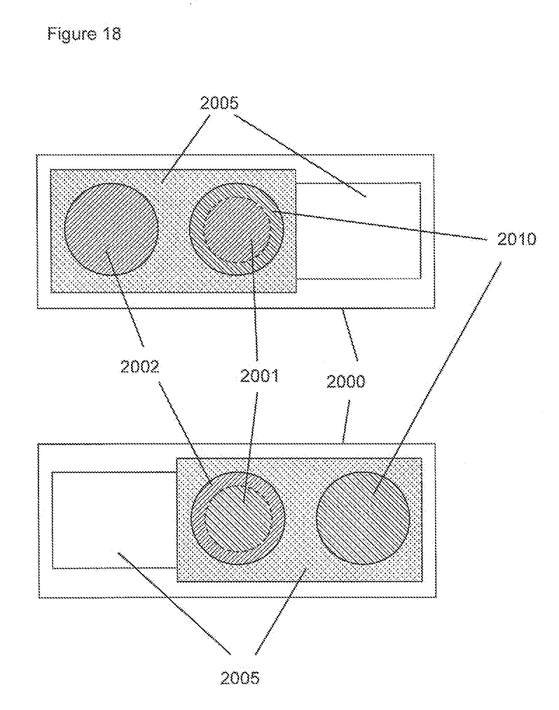

FIG. 18 shows an alternative embodiment which employs a sliding dual filter holder (2005) with integrated IR pass filter (2002) and integrated IR block filter (2010). The sliding filter holder allows either the IR pass filter or an IR block filter to be positioned over the lens (2001). When the IR block filter is in position (top drawing in FIG. 18), unwanted IR light is blocked for maximum image quality in other camera applications such as a web conferencing. When the IR pass filter is in position (bottom drawing in FIG. 18), only wavelengths of light similar to the IR LED(s) in the remote control are allowed to reach the camera, enhancing performance of the described cursor control system. This mechanism may also include a sensor similar to that described for the sliding single filter mechanism to signal the microprocessor which of the two filters is currently been deployed. This mechanism may also include an electromechanical mechanism similar to that described for the sliding single filter mechanism to automatically deploy either of the two filters.

It will be appreciated by those skilled in the art that the foregoing is merely an illustration of the present invention in currently preferred implementations. A wide variety of modifications to the illustrated embodiments are possible while remaining within the scope of the present convention. Therefore, the above description should not be viewed as limiting but merely exemplary in nature.

What is claimed is:

1. An interactive media system with dual mode camera operation, comprising:
a display;
a camera assembly integrated with or adjacent to the display and including a camera having a lens oriented toward an area in front of the display, the assembly further including a movable filter holder and a filter configured in the holder, wherein said filter holder is movable from a first position where the filter covers the camera lens to a second position where the filter is not covering the lens;
a remote control including an LED; and
a processor implementing a tracking algorithm based on images of the LED from the camera with the filter in said first position and controlling a cursor or other object on the display using the detected LED position.

2. An interactive media system with dual mode camera as set out in claim 1, wherein said LED is an IR LED and said filter is an IR pass and visible light blocking filter.

3. An interactive media system with dual mode camera as set out in claim 1, further comprising an actuator for moving the filter from said first position to said second position.

4. An interactive media system with dual mode camera as set out in claim 3, wherein said actuator is activated by a control signal in response to initiation of tracking operation by a user.

5. An interactive media system with dual mode camera as set out in claim 1, wherein said movable filter holder comprises a slidable holder.

6. An interactive media system with dual mode camera as set out in claim 1, wherein said movable filter holder comprises a rotatable holder.

7. An interactive media system with dual mode camera as set out in claim 2, further comprising a second filter configured in said movable filter holder wherein said second filter is an IR blocking filter and wherein said second filter covers said camera lens when said filter holder moves to said second position.

8. A method of dual mode operation of an interactive media system including a display, a camera and a remote control having an LED, comprising:
operating the interactive media system in a first mode where a cursor or other object displayed on the display is controlled by tracking movement of the remote control by tracking the LED using the camera with a filter in a first position in place over the camera lens to enhance the LED tracking operation;
moving the filter to a second position not covering the camera lens; and
operating the interactive media system in a second mode with the camera employed for a web video application with the filter in the second position.

9. A method of dual mode operation of an interactive media system as set out in claim 8, wherein said LED is an IR LED and said filter is an IR pass and visible light blocking filter.

10. A method of dual mode operation of an interactive media system as set out in claim 9, wherein a second IR blocking filter is moved to cover said camera lens when the interactive media system operates in said second mode.
